(19) United States
(12) Patent Application Publication
(10) Pub. No.: US 2026/0129648 A1
(43) Pub. Date: May 7, 2026

(54) PHYSICAL DOWNLINK CONTROL CHANNEL (PDCCH) MONITORING DURING SKIPPED MEASUREMENT

(71) Applicant: Lenovo (United States) Inc., Morrisville, NC (US)

(72) Inventors: Joachim Löhr, Wiesbaden (DE); Hossein Bagheri, Urbana, IL (US)

(73) Assignee: Lenovo (United States) Inc., Morrisville, NC (US)

(21) Appl. No.: 18/939,719

(22) Filed: Nov. 7, 2024

(51) Int. Cl. H04W 72/23; H04W 76/28; H04W 76/38

(52) U.S. Cl. CPC H04W 72/23; H04W 76/28; H04W 76/38

(57) ABSTRACT

Various aspects of the present disclosure relate to physical downlink control channel (PDCCH) monitoring during skipped measurement. A user equipment (UE) may be configured to, capable of, or operable to receive an indication to skip measurement for radio resource management, where the measurement is associated with a duration, and monitors PDCCH during the duration based at least in part on the received indication to skip the measurement. A network equipment (NE) may be configured to, capable of, or operable to transmit an indication to skip measurement for radio resource management, where the measurement is associated with a duration, and transmits PDCCH during the duration.

### TECHNICAL FIELD

The present disclosure relates to wireless communications, and more specifically to discontinuous reception (DRX) operation in wireless communications systems.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive an indication to skip measurement for radio resource management, wherein the measurement is associated with a duration; and monitor physical downlink control channel (PDCCH) during the duration based at least in part on the received indication to skip the measurement.

A processor for wireless communication is described. The processor may be configured to, capable of, or operable to perform one or more operations as described herein. For example, the processor may be configured to, capable of, or operable to receive an indication to skip measurement for radio resource management, wherein the measurement is associated with a duration; and monitor PDCCH during the duration based at least in part on the received indication to skip the measurement.

A method performed or performable by a UE for wireless communication is described. The method may include receiving an indication to skip measurement for radio resource management, wherein the measurement is associated with a duration; and monitoring PDCCH during the duration based at least in part on the received indication to skip the measurement.

In some implementations of the UE, the processor, and the method described herein, the indication to skip the measurement includes an indication to skip a measurement gap, and indicates that the UE is to enable wireless communication during the duration.

Some implementations of the UE, the processor, and the method described herein, the UE, the processor, and the method may further be configured to, capable of, operable to, performed to, or performable to receive a timer configuration; and start (e.g., enable, activate, trigger) a timer in accordance with the received timer configuration and based at least in part on the indication to skip the measurement. In some implementations of the UE, the processor, and the method described herein, the PDCCH is monitored further based at least in part on the timer.

In some implementations of the UE, the processor, and the method described herein, the timer is started (e.g., enabled, activated, triggered) at a first offset after the indication to skip the measurement.

In some implementations of the UE, the processor, and the method described herein, the timer configuration indicates the first offset.

In some implementations of the UE, the processor, and the method described herein, the timer includes a DRX inactivity timer.

In some implementations of the UE, the processor, and the method described herein, the indication to skip the measurement includes one or more of PDCCH or downlink control information (DCI).

In some implementations of the UE, the processor, and the method described herein, the indication to skip the measurement is received during a PDCCH monitoring occasion.

Some implementations of the UE, the processor, and the method described herein, the UE, the processor, and the method may further be configured to, capable of, operable to, performed to, or performable to receive configuration information that indicates the PDCCH monitoring occasion.

In some implementations of the UE, the processor, and the method described herein, the configuration information indicates a second offset before a measurement gap for the PDCCH monitoring occasion.

Some implementations of the UE, the processor, and the method described herein, the UE, the processor, and the method may further be configured to, capable of, operable to, performed to, or performable to transmit uplink control information (UCI) during the duration. In some implementations of the UE, the processor, and the method described herein, the UCI includes one or more of channel state information (CSI) or sounding reference signal (SRS).

An NE (e.g., a base station) for wireless communication is described. The NE may be configured to, capable of, or operable to perform one or more operations as described herein. For example, the NE may be configured to, capable of, or operable to transmit an indication to skip measurement for radio resource management, wherein the measurement is associated with a duration; and transmit PDCCH during the duration.

A processor for wireless communication is described. The processor may be configured to, capable of, or operable to perform one or more operations as described herein. For example, the processor may be configured to, capable of, or operable to transmit an indication to skip measurement for radio resource management, wherein the measurement is associated with a duration; and transmit PDCCH during the duration.

A method performed or performable by an NE (e.g., base station) for wireless communication is described. The method may include transmitting an indication to skip measurement for radio resource management, wherein the measurement is associated with a duration; and transmit PDCCH during the duration.

In some implementations of the NE, the processor, and the method described herein, the indication to skip the measurement includes an indication to skip a measurement gap, and an indication for a UE to enable wireless communication during the duration.

Some implementations of the NE, the processor, and the method described herein, the NE, the processor, and the method may further be configured to, capable of, operable to, performed to, or performable to transmit a timer configuration for a timer to be started (e.g., activated, enabled, triggered) in response to the indication to skip the measurement.

In some implementations of the NE, the processor, and the method described herein, the timer configuration includes a first offset to be applied for starting (e.g., activating, enabling) the timer in response to the indication to skip the measurement.

Some implementations of the NE, the processor, and the method described herein, the NE, the processor, and the method may further be configured to, capable of, operable to, performed to, or performable to transmit configuration information including an indication of a PDCCH monitoring occasion for receiving the indication to skip the measurement.

In some implementations of the NE, the processor, and the method described herein, the indication to skip the measurement includes one or more of PDCCH or DCI.

### BRIEF DESCRIPTION OF THE DRAWINGS

FIG. 1 illustrates an example of a wireless communications system in accordance with aspects of the present disclosure.

FIGS. 2 and 3 illustrate examples of timing diagrams in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method in accordance with aspects of the present disclosure.

FIG. 8 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. To manage signal quality as part of utilizing time-frequency resources for wireless communication, a UE can perform various measurements on downlink signal received from different transmission sources, for example, an NE. Examples of measurements include signal quality measurements, timing-related measurements (e.g., for UE handovers between NE), interference measurements (e.g., for identifying interference sources), etc. Further, measurements can be performed on different frequency configurations, such as intra-frequency measurements of signal from different cells on a same frequency, inter-frequency measurements of signal from different cells on different frequencies, inter-radio access technology (RAT) signal measurements of signal originating from different RAT sources, etc.

To enable UEs to perform measurements, measurement gaps represent periods (e.g., in time, symbols, slots, etc.) in which a UE can perform measurements. A measurement gap, for example, represents a period in which a UE temporarily suspends (e.g., pauses, skips) wireless communication (e.g., signal transmission and signal reception) to perform measurements. Measurement gaps can have a defined gap length and periodicity, such as based on different wireless access technologies and/or standards. In NR, for example, measurement gap lengths of 1.5, 3, 3.5, 4, 5.5, and 6 milliseconds (ms) with measurement gap repetition periodicities of 20, 40, 80, and 160 ms are defined. The use of measurement gaps can depend on different factors such as UE capability, active UE bandwidth part (BWP), current UE operating frequency, etc.

During measurement gaps, measurements can include measurements performed on synchronization signal blocks (SSBs) of neighbor cells. A network, for example, provides (e.g., configures) a UE with the timing of neighbor cell SSBs using synchronization signal physical broadcast channel (SS/PBCH) block measurement timing configuration (SMTC). A measurement gap and SMTC duration can be configured such that the UE can identify and measure the SSBs within the SMTC window, for example, the SMTC duration can be sufficient to accommodate SSBs that are transmitted. For SSB based intra-frequency measurements, the NE can configure measurement gaps if UE configured BWPs exclude (e.g., do not contain) the frequency domain resources of the SSB associated with an initial downlink (DL) BWP.

For SSB based inter-frequency measurements, the NE can configure measurement gaps in several scenarios. For instance, the NE can configure measurement gaps if a UE supports per-frequency range (FR) measurement gaps and if a carrier frequency to be measured is in a same FR as the serving cells. Further, the NE can configure measurement gaps if a UE exclusively supports per-UE measurement gaps. In such cases, a measurement object can be configured on any frequency range (e.g., FR1 or FR2) and a measurement gap can be configured by the NE. For inter-RAT measurements, a measurement gap configuration can be provided when a UE only supports per-UE measurement gaps, or a UE supports per-FR measurement gaps and at least one serving cell is in FR1.

In some scenarios, a measurement gap can be skipped such that a UE does not perform measurement operations during a skipped measurement gap. For instance, DCI can indicate that a UE is to skip a measurement gap. The ability to utilize a skipped measurement gap for wireless communication (e.g., signal reception and transmission), however, presents some challenges. For instance, as part of DRX operation of a UE, if the UE is not in DRX active time the UE may not be monitoring PDCCH if a measurement gap is indicated as skipped. A DRX inactivity timer may keep the UE awake during a skipped measurement gap, but the DRX inactivity timer may not be long enough to cover a measurement gap offset plus measurement operation. An extended DRX inactivity timer, for instance, may negatively impact the UE power consumption when a new UE transmission is scheduled. Further, if a measurement gap occasion overlaps with or is sufficiently close to an active duration of the UE (also referred to as an ON duration), the UE may not have an opportunity to monitor PDCCH that indicates measurement gap skipping. As a measurement configuration considers SSB occasions, while ON duration considers traffic patterns and quality of service (QoS) requirements, alignment of measurement configuration and ON duration may be difficult to ensure that measurement occasions come at least offset after ON duration.

The present disclosure provides solutions to enable wireless communication (e.g., reception and transmission) of data traffic during a measurement gap which is indicated to be skipped. The described solutions, for instance, can enable a UE to be in a DRX active time during a skipped measurement gap. A DRX related behavior, for example, is described in which a measurement gap which is skipped (e.g., NE indicates to skip the measurement gap) is considered as DRX active time such that wireless communication by the UE can occur. A DRX timer is described that can be started (e.g., activated, enabled, triggered) in response to receiving an indication that a measurement gap is to be skipped (e.g., ignored). While the timer is running, the UE can be in the DRX active time and monitoring PDCCH. The timer can be started (e.g., activated, enabled, triggered) at an offset after receiving the indication (e.g., a PDCCH indicating to skip a measurement gap). A DRX inactivity timer (e.g., drx-InactivityTimer) can be started in response to a PDCCH indicating measurement gap skipping, and for DCI-only cases the DRX inactivity timer can be started. In an example, the UE may be configured with PDCCH monitoring occasions for reception of measurement gap skipping PDCCH and an offset before a measurement gap is configured, where the UE can monitor for a measurement gap skipping PDCCH.

By performing the described techniques, a device in a wireless communications system can perform wireless communication in conjunction with a skipped measurement gap (e.g., a duration when a UE does not perform measurements), which can enable more efficient use of time-frequency resources.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

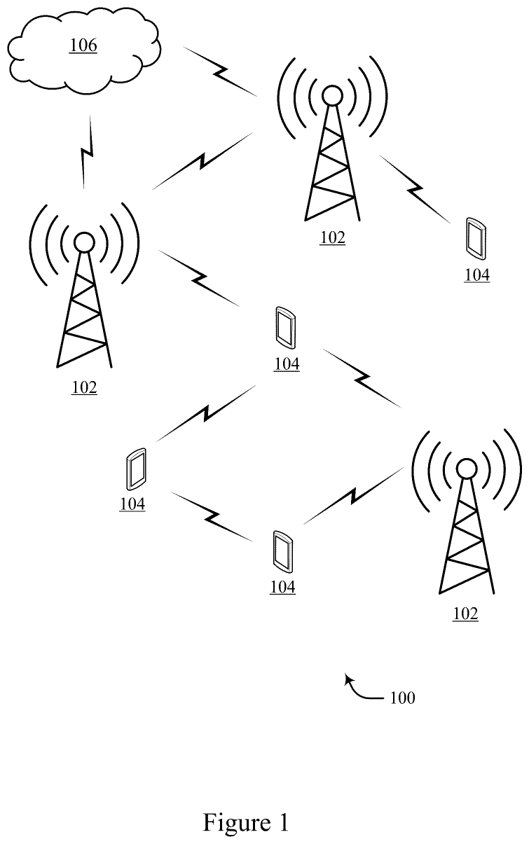

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives (obtains, retrieves) an indication to skip measurement for radio resource management, where the measurement is associated with a duration. The UE 104 monitors (detects, receives, determines) PDCCH during the duration based at least in part on the received indication to skip the measurement. An NE 102 transmits (sends, communicates) an indication to skip measurement for radio resource management, where the measurement is associated with a duration. The NE 102 transmits PDCCH during the duration.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

In scenarios, extended Reality (XR) is an umbrella term for different types of realities including virtual reality (VR), augment reality (AR), and mixed reality (MR). VR, for instance, represents a rendered version of a delivered visual and audio scene. The rendering is designed to mimic the visual and audio sensory stimuli of the real world as naturally as possible to an observer or user as they move within the limits defined by the application. VR usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

AR represents scenarios where a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed. MR represents an advanced form of AR where some virtual elements are inserted into the physical scene with the intent to provide the illusion that these elements are part of the real scene.

XR can refer to real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many XR and cloud gaming (CG) use cases are characterized by quasi-periodic traffic (with possible jitter) with high data rate in DL (i.e., video steam) combined with the frequent uplink (UL) (e.g., pose/control update) and/or UL video stream. Both DL and UL traffic are also characterized by relatively strict packet delay budget (PDB). The set of anticipated XR and CG services has a certain variety and characteristics of the data streams (e.g., video) may change “on-the-fly”, while the services are running over NR. Therefore, additional information on the running services from higher layers, e.g. the QoS flow association, frame-level QoS, PDU set-based QoS, XR specific QoS, etc., may be beneficial to facilitate informed choices of radio parameters. XR application awareness by UE and gNB can improve the user experience, improve the NR system capacity in supporting XR services, and reduce the UE power consumption.

An application data unit (ADU) or PDU set is the smallest unit of data that can be processed independently by an application, e.g., processing for handling out-of-order traffic data. A video frame can be an I-frame, P-frame, or can be composed of I-slices, and/or P-slices. I-frames/I-slices can be more important and larger than P-frames/P-slices. A PDU set can be one or more I-slices, P-slices, I-frame, P-frame, or a combination thereof. A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient XR service delivery, e.g., in terms of satisfying XR service requirements for a greater number of UEs, or in terms of UE power saving.

The latency requirement of XR traffic in RAN side (e.g., air interface) can be modelled as PDB. The PDB is a limited time budget for a packet to be transmitted over the air from a gNB to a UE. For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered. The value of PDB may vary for different applications and traffic types, which can be 10-20 ms depending on the application (see, e.g., 3GPP technical report (TR) 26.926).

5G arrival time of data bursts on the downlink can be quasi periodic, e.g., periodic with jitter. Some of the factors leading to jitter in burst arrival include varying server render time, encoder time, real-time transport protocol (RTP) packetization time, link between server and 5G gateway etc. 3GPP agreed simulation assumptions for XR evaluation model DL traffic arrival jitter using truncated Gaussian distribution with mean: Oms, standard deviation: 2 ms, range: [−4 ms, 4 ms] (baseline), [−5 ms, 5 ms]. Applications can have a certain delay requirement on a PDU set, that may not be adequately translated into packet delay budget requirements. For example, if the PDU set delay budget (PSDB) is 10 ms, then PDB can be set to 10 ms only if all packets of the PDU set arrive at the 5G system at the same time. If the packets are spread out, then the PDU set delay budget is measured either in terms of the arrival of the first packet of the PDU set or the last packet of the PDU set. In either case, a given PSDB will result in different PDB requirements on different packets of the PDU set. It is observed that specifying the PSDB to the 5G system can be beneficial.

Regarding delay aware communication, if the scheduler and/or the UE is aware of delay budgets for a packet/ADU, the NE can take this knowledge into account in scheduling transmissions, e.g., by giving priority to transmissions close to their delay budget limit, and by not scheduling (e.g., UL) transmissions. The UE can also take advantage of such knowledge to determine: 1) if an UL transmission (e.g., physical uplink control channel (PUCCH) in response to physical downlink shared channel (PDSCH), UL pose, or physical uplink shared channel (PUSCH)) corresponding to a transmission that exceeds its delay budget can be dropped (additionally, no need to wait for re-transmission of a PDSCH and no need to keep the erroneously received PDSCH in buffer for soft combining with a re-transmission that never occurs); and/or 2) how much of the UE's channel occupancy time in case of using unlicensed spectrum can be shared with the gNB. The remaining delay budget 1) for a DL transmission can be indicated to the UE in a DCI (e.g., for a packet of a video frame/slice/ADU) or via a medium access control (MAC) control element (CE) (MAC-CE) (e.g., for an ADU/video frame/slice) and 2) for an UL transmission can be indicated to the gNB via an UL transmission such as UCI, PUSCH transmission, etc.

Regarding XR application awareness at the RAN, XR-Awareness relies on QoS flows, PDU Sets, data bursts and traffic assistance information (see, e.g., 3GPP technical specification (TS) 23.501). To enable PDU set based QoS handling, PDU set QoS Parameters may be provided by the session management function (SMF) to the gNB as part of the QoS profile of the QoS flow, such as one or more of:

PDU set delay budget (PSDB): as defined in TS 23.501, upper bound for the duration between the reception time of the first PDU (at the UPF for DL, at the UE for UL) and the time when all PDUs of a PDU set have been successfully received, e.g., at the UE in DL or the UPF in UL. A QoS flow is associated with only one PSDB, and when available, it applies to both DL and UL and supersedes the PDB of the QoS flow. The access network (AN) PSDB can be derived by subtracting the CN PDB from the PSDB.

PDU Set Error Rate (PSER): as defined in TS 23.501, upper bound for a rate of non-congestion related PDU Set losses between RAN and the UE. A QoS Flow is associated with only one PSER, and when available, it applies to both DL and UL and supersedes the packet error rate (PER) of the QoS flow. A PDU set can be considered as successfully delivered when all PDUs of a PDU set are delivered successfully.

PDU set integrated handling information (PSIHI): indicates whether all PDUs of the PDU Set are needed for the usage of PDU set by application layer, as defined in TS 23.501. The PDU Set QoS parameters are common for all PDU Sets within a QoS flow.

In addition, the UPF can identify PDUs that belong to PDU Sets, and may determine the following PDU Set Information which it sends to the gNB in the general packet radio service (GPRS) Tunnelling Protocol-User Plane (GTP-U) header: PDU set sequence number; Indication of end PDU of the PDU set; PDU sequence number within a PDU Set; PDU set size in bytes; PDU set importance (PSI), which identifies the relative importance of a PDU set compared to other PDU sets within the same QoS flow.

Traffic assistance information may also be provided by 5GC to the gNB: Via time sensitive communication assistance information (TSCAI) (for both guaranteed bit rate (GBR) and non-GBR QoS flows), e.g., UL and/or DL Periodicity and N6 jitter information (e.g. between UPF and Data Network) associated with the DL Periodicity; via indication of end of data burst in the GTP-U header of the last PDU in downlink. In the uplink, the UE may need to be able to identify PDU sets and data bursts dynamically, including PSI.

Regarding jitter aspects of XR, the packet arrival rate can be determined by the frame generation rate, e.g., 60 fps. Accordingly, the average packet arrival periodicity is given by the inverse of the frame rate, e.g., 16.6667 ms= 1/60 fps. The periodic arrival without jitter gives the arrival time at gNB for packet with index k (=1, 2, 3 . . . ) as

$$k / F * 1000 [ ms ] ,$$

where F is the given frame generation rates (per second).

Note that this periodic packet arrival implicitly assumes fixed delay contributed from network side including fixed video encoding time, fixed network transfer delay, etc. However, in some systems, the varying frame encoding delay and network transfer time introduces jitter in packet arrival time at an NE. In this model, the jitter is modelled as a random variable added on top of periodic arrivals. The jitter follows truncated Gaussian distribution with following statistical parameters shown in Table 1.

TABLE 1
Statistical parameters for jitter

| | | Baseline value | Optional value |
|---|---|---|---|
| Parameter | unit | for evaluation | for evaluation |
| Mean | ms | 0 | |
| STD | ms | 2 | |
| Truncation range | ms | [−4, 4] | [−5, 5] |

The given parameter values and considered frame generation rates (60 or 120 in this model) ensure that packet arrivals are in order (e.g., arrival time of a next packet is always larger than that of the previous packet). Thus, the periodic arrival with jitter gives the arrival time for packet with index k (=1, 2, 3 . . . ) as

$$offset + k / F * 1000 + J [ ms ] ,$$

where F is the given frame generation rates (per second) and J is a random variable capturing jitter. Note that actual traffic arrival timing of traffic for each UE could be shifted by the UE specific arbitrary offset.

Implementations described herein provide solutions for PDCCH monitoring during skipped measurement. In implementations, a UE/MAC considers a measurement gap/restriction which is indicated by an NE as to be “skipped” in order to enable transmit (Tx) and/or receive (Rx) as DRX ActiveTime. For instance, the UE/MAC determines that a measurement gap (e.g., time period which is configured as a measurement gap) is to be skipped as DRX ActiveTime in response to receiving an indication from an NE. The UE can according to this implementation monitor PDCCH during the time period of a measurement gap, e.g., where an indication is received from the NE (e.g. gNB) indicating that the measurement gap is to be skipped in order to enable Tx/Rx during the time period. In one example, a DCI is received prior to a measurement gap/restriction which indicates that a following measurement gap is to be skipped. For instance, the UE is not to stop Rx/Tx during the measurement gap for radio resource management (RRM) measurement purposes. In response to the reception of DCI/PDCCH indicating the measurement gap skipping, the UE can consider a (following) time period configured as measurement gap as DRX ActiveTime and monitor PDCCH during the measurement gap. In one implementation, radio resource control (RRC) signaling can be used to indicate whether a measurement gap is to be used for Rx/Tx, e.g., the measurement gap is to be skipped. In implementations, a UE considers the time period of a measurement gap/restriction which is indicated to be skipped/cancelled by RRC signaling as DRX ActiveTime.

In implementations, if the measurement gap skipping indication is at least certain time ‘d’ prior to the measurement gap, the measurement gap duration is considered as DRX ActiveTime. For instance, ‘d=W+Delta’, where ‘W’ represents the minimum offset required for skipping between measurement gap skipping DCI and the corresponding measurement gap, and ‘Delta’ is a pre-determined value which can depend on UE capability, defined in the standards, and/or can depend on subcarrier spacing (SCS). In an implementation, ‘Delta=0’. If the scheduling DCI which indicates skipping of the measurement gap is of a DCI format associated with scheduling UL transmissions, the measurement gap may not be considered as DRX ActiveTime. In an example only part of the measurement gap duration that belongs to the same DRX cycle is considered as DRX ActiveTime. Example abstract syntax notation (ASN.1) for implementations described herein is presented below.

For DRX, the MAC entity may be configured by RRC with a DRX functionality that controls the UE's PDCCH monitoring activity for the MAC entity's cell radio network temporary identifier (C-RNTI), CI-RNTI, configured scheduling (CS)-RNTI, interruption (INT)-RNTI, slot format indicator (SFI)-RNTI, semi-persistent CSI (SP-CSI)-RNTI, transmit power control-physical uplink control channel (TPC-PUCCH)-RNTI, transmit power control-physical uplink shared channel (TPC-PUSCH)-RNTI, transmit power control-sounding reference symbols (TPC-SRS)-RNTI, artificial intelligence radio network temporary identifier (AI-RNTI), sidelink (SL)-RNTI, SL-configured scheduling (CS)-RNTI, SL Semi-Persistent Scheduling V-RNTI and cellDTRX-RNTI. When using DRX operation, the MAC entity may also monitor PDCCH according to requirements found in other clauses of the TS. When in RRC_CONNECTED, if DRX is configured, for all the activated Serving Cells, the MAC entity may monitor the PDCCH discontinuously using the DRX operation as specified; otherwise the MAC entity may monitor the PDCCH as specified in TS 38.213.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL, DL or SL transmission for the MAC entity;
drx-RetransmissionTimerDL (per DL hybrid automatic repeat request (HARQ) process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-NonIntegerLongCycleStartOffset (optional): the Long DRX cycle and drx-StartOffset which defines the subframe where the Long and Short DRX cycle start, when the length of the Long DRX cycle and/or the short DRX cycle is not an integer;
drx-ShortCycle (optional): the Short DRX cycle;
drx-NonIntegerShortCycle (optional): the Short DRX cycle whose length is not an integer;
drx-ShortCycleTimer (optional): the duration the UE may follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per sidelink process): the maximum duration until a grant for SL retransmission is received;
drx-HARQ-RTT-TimerSL (per sidelink process): the minimum duration before an SL retransmission grant is expected by the MAC entity;
drx-LastTransmissionUL (optional): the configuration to start drx-HARQ-RTT-TimerUL after the last transmission within a bundle;
ps-Wakeup (optional): the configuration to start associated drx-onDurationTimer in case downlink control information of power saving (DCP) is monitored but not detected;
ps-TransmitOtherPeriodicCSI (optional): the configuration to report periodic CSI that is not L1-reference signal received power (RSRP) on PUCCH during the time duration indicated by drx-onDurationTimer in case DCP is configured but associated drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started;
downlinkHARQ-FeedbackDisabled (optional): the configuration to disable HARQ feedback per DL HARQ process;
uplinkHARQ-Mode (optional): the configuration to set HARQmodeA or HARQmodeB per UL HARQ process;
disableCG-RetransmissionMonitoring (optional): the configuration to disable starting drx-HARQ-RTT-TimerUL for UL transmission over a configured uplink grant;
drx-TimeReferenceSFN (optional): the configuration to indicate how UE initializes of DRX_SFN_COUNTER.

The following UE variable is used for the DRX operation if drx-NonIntegerLongCycleStartOffset is configured:
DRX_SFN_COUNTER: the counter that increments when system frame number (SFN) changes to 0. The maximum value of this counter is at least 65535.

Serving cells of a MAC entity may be configured by RRC in two DRX groups with separate DRX parameters. When RRC does not configure a secondary DRX group, there may be only one DRX group and all serving cells belong to that one DRX group. When two DRX groups are configured, each serving cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-NonIntegerLongCycleStartOffset, drx-ShortCycle (optional), drx-NonIntegerShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending (as described in clause 5.4.4 or 5.22.1.5). If this Serving Cell is part of a non-terrestrial network, the Active Time is started after the Scheduling Request transmission that is performed when the SR_COUNTER is 0 for all the scheduling request (SR) configurations with pending SR(s) plus the UE-gNB roundtrip time (RTT); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a); or
there is an ongoing random access channel (RACH)-less layer 1/layer 2 (L1/L2) triggered mobility (LTM) cell switch; or
there is an ongoing RACH-less handover in a terrestrial network.
there is a configured measurement gap/restriction which is indicated by a PDCCH to be skipped by the MAC entity.

In implementations, a UE/MAC doesn't start a DRX related timer during a measurement gap which was indicated as to be skipped. The UE, for instance, considers the skipped measurement gap as DRX ActiveTime as outlined in the described implementations but doesn't start a DRX related timer as specified for the legacy DRX operation. In one example, MAC doesn't start a drx-InactivityTimer in response to the reception of a PDCCH indicating an initial UL/DL transmission during a skipped measurement gap. By not starting a DRX related timer, the DRX ActiveTime may not be extended beyond the duration of the configured measurement gap. In one implementation, specific DRX related timers can be started/restarted during a skipped measurement gap. In one example the DRX timers which are related to retransmissions (e.g. drx-HARQ-RTT-TimerDL, drx-HARQ-RTT-TimerUL, drx-HARQ-RTT-TimerDL, drx-HARQ-RTT-TimerUL) can be started, however the drx-InactivityTimer may not be started in a skipped measurement gap.

In implementations, a new timer is started in response to the reception of an indication from a NE indicating to skip a measurement gap/restriction. For instance, the new timer is a DRX related timer which controls the DRX ActiveTime of the UE. In one example the UE monitors PDCCH (e.g., UE is in ActiveTime) while the new timer is running. In one example, the new timer is started upon the reception of a DCI/PDCCH indicating to skip a measurement gap/restriction.

In an example, the new timer is started upon the reception of the first DCI/PDCCH indicating to skip a measurement gap/restriction and the new timer is not restarted for subsequent DCIs/PDCCHs indicating to skip the measurement gap/restriction. In one example the new timer is started at a preconfigured offset from the slot where a PDCCH indicating to skip a measurement gap was received. The offset may be configured in ms or number of symbols/slots. In one example, the new timer is started at the beginning of a measurement gap which has been indicated to be skipped. For cases where RRC signaling is used to configure skipped measurement gaps, the new timer is started at the beginning of a measurement gap which was configured to be skipped.

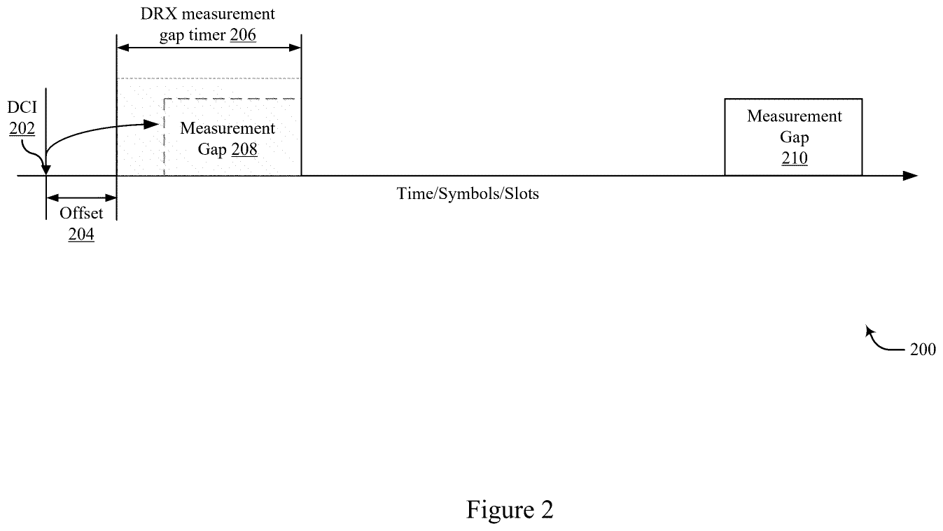

FIG. 2 illustrates an example timing diagram 200 in accordance with aspects of the present disclosure. The timing diagram 200 may implement various aspects of the present disclosure described herein. For example, the timing diagram 200 may include one or more operations and/or signaling performed by one or more of a NE or a UE as described herein. In the following description of the timing diagram 200, one or more operations and/or signaling may be performed in different orders or at different times than the example order or times shown. Some operations and/or signaling may also be omitted, or other operations and/or signaling may be added.

By way of example, a NE 102 (e.g., a base station) may transmit, and a UE 104 may receive, a DCI 202. The DCI 202, for example, may indicate for the UE 104 to skip a measurement gap 208 (also referred to as a skipped measurement gap). Additionally, or alternatively, the NE 102 (e.g., a base station) may transmit, and the UE 104 may receive a PDCCH, including the DCI 202. In some examples, an offset 204 may be configured for the UE 104. The offset 204 may represent an offset value in a time domain (e.g., symbols, slots). In some examples, the offset 204 may represent an offset value between a first symbol, in which the UE 104 receives the DCI 202 (and/or a PDCCH carrying the DCI 202) and a second symbol, in which the UE 104 starts (e.g., activated, enables, triggers) a DRX measurement gap timer 206. In some other examples, the offset 204 may represent an offset value between a first slot, in which the UE 104 receives the DCI 202 (and/or a PDCCH carrying the DCI 202) and a second slot, in which the UE 104 starts (e.g., activated, enables, triggers) the DRX measurement gap timer 206.

While the DRX measurement gap timer 206 is running, the UE 104 may be operating in the DRX active time to monitor for PDCCH. In the example of FIG. 2, the measurement gap 210 may represent a period (e.g., in time, symbols, slots, etc.) in which measurement is not skipped by the UE 104. Put another way, the measurement gap 210 may be a measurement gap that is not skipped. The UE 104 may utilize the measurement gap 210 to perform measurements on a target carrier frequency, inter-frequency measurements, intra-frequency measurements, inter-RAT measurements, etc. The following represents example ASN.1 for implementations described herein, such as for inclusion in relevant 3GPP standards.

For DRX, a MAC entity of the UE 104 may be configured via RRC (e.g., one or more RRC configuration message) with a DRX functionality that controls the UE's 104 PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI, SL Semi-Persistent Scheduling V-RNTI and cellDTRX-RNTI. When using DRX operation, the MAC entity of the UE 104 may also monitor PDCCH according to parameters defined in the 3GPP specification. When in an RRC_CONNECTED, if DRX is configured, for all the activated serving cells, the MAC entity of the UE 104 may monitor the PDCCH discontinuously using the DRX operation as specified; otherwise the MAC entity may monitor the PDCCH as specified in TS 38.213.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL, DL or SL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-NonIntegerLongCycleStartOffset (optional): the Long DRX cycle and drx-StartOffset which defines the subframe where the Long and Short DRX cycle start, when the length of the Long DRX cycle and/or the short DRX cycle is not an integer;
drx-ShortCycle (optional): the Short DRX cycle;
drx-NonIntegerShortCycle (optional): the Short DRX cycle whose length is not an integer;
drx-ShortCycleTimer (optional): the duration the UE may follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per sidelink process): the maximum duration until a grant for SL retransmission is received;
drx-HARQ-RTT-TimerSL (per sidelink process): the minimum duration before an SL retransmission grant is expected by the MAC entity;
drx-LastTransmissionUL (optional): the configuration to start drx-HARQ-RTT-TimerUL after the last transmission within a bundle;
ps-Wakeup (optional): the configuration to start associated drx-onDurationTimer in case DCP is monitored but not detected;
ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started;
downlinkHARQ-FeedbackDisabled (optional): the configuration to disable HARQ feedback per DL HARQ process;
uplinkHARQ-Mode (optional): the configuration to set HARQmodeA or HARQmodeB per UL HARQ process;
disableCG-RetransmissionMonitoring (optional): the configuration to disable starting drx-HARQ-RTT-TimerUL for UL transmission over a configured uplink grant;
drx-TimeReferenceSFN (optional): the configuration to indicate how UE initializes of DRX_SFN_COUNTER.

The following UE variable is used for the DRX operation if drx-NonIntegerLongCycleStartOffset is configured:
DRX_SFN_COUNTER: the counter that increments when SFN changes to 0. The maximum value of this counter is at least 65535.

Serving cells of a MAC entity may be configured by RRC in two DRX groups with separate DRX parameters. When RRC does not configure a secondary DRX group, there may be only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-Inactivity Timer. The DRX parameters that are common to the DRX groups are: drx-SlotOffset, drx-RetransmissionTimerDL, drx-RetransmissionTimerUL, drx-LongCycleStartOffset, drx-NonIntegerLongCycleStartOffset, drx-ShortCycle (optional), drx-NonIntegerShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-ResponseWindow (as described in clause 5.1.4a) is running; or
drx-MgTimer is running; or
a Scheduling Request is sent on PUCCH and is pending (as described in clause 5.4.4 or 5.22.1.5). If this Serving Cell is part of a non-terrestrial network, the Active Time is started after the Scheduling Request transmission that is performed when the SR_COUNTER is 0 for all the SR configurations with pending SR(s) plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a); or
there is an ongoing RACH-less LTM cell switch; or
there is an ongoing RACH-less handover in a terrestrial network.
1> if a DRX group is in Active Time:
   2> monitor the PDCCH on the Serving Cells in this DRX group as specified in TS 38.213;
   2> if the PDCCH indicates a DL transmission; or
   2> if the PDCCH indicates a one-shot HARQ feedback as specified in clause 9.1.4 of TS 38.213; or
   2> if the PDCCH indicates a retransmission of HARQ feedback as specified in clause 9.1.5 of TS 38.213:
      3> if this Serving Cell is configured with downlinkHARQ-FeedbackDisabled:
         4> if the corresponding HARQ process is configured with HARQ feedback enabled:
         5> set HARQ-RTT-TimerDL-NTN for the corresponding HARQ process equal to drx-HARQ-RTT-TimerDL plus the latest available UE-gNB RTT value;
         5> start the HARQ-RTT-TimerDL-NTN for the corresponding HARQ process in the first symbol after the end of the corresponding transmission carrying the DL HARQ feedback.
      3> else:
         4> start or restart the drx-HARQ-RTT-TimerDL for the corresponding HARQ process(es) whose HARQ feedback is reported in the first symbol after the end of the corresponding transmission carrying the DL HARQ feedback.
   NOTE: When HARQ feedback is postponed by PDSCH-to-HARQ_feedback timing indicating an inapplicable kl value, as specified in TS 38.213, the corresponding transmission opportunity to send the DL HARQ feedback is indicated in a later PDCCH requesting the hybrid automatic repeat request acknowledgement (HARQ-ACK) feedback.
      3> stop the drx-RetransmissionTimerDL for the corresponding HARQ process(es) whose HARQ feedback is reported;
      3> stop the drx-RetransmissionTimerDL-PTM for the corresponding HARQ process;
      3> if the PDSCH-to-HARQ_feedback timing indicate an inapplicable kl value as specified in TS 38.213:
         4> start the drx-RetransmissionTimerDL in the first symbol after the (end of the last) PDSCH transmission (within a bundle) for the corresponding HARQ process.
   2> if the PDCCH indicates a UL transmission:
      3> if this Serving Cell is configured with uplinkHARQ-Mode:
         4> if the corresponding HARQ process is configured as HARQModeA:
         5> set HARQ-RTT-TimerUL-NTN for the corresponding HARQ process equal to drx-HARQ-RTT-TimerUL plus the latest available UE-gNB RTT value;
         5> if drx-LastTransmissionUL is configured:
         6> start the HARQ-RTT-TimerUL-NTN for the corresponding HARQ process in the first symbol after the end of the last transmission (within a bundle) of the corresponding PUSCH transmission.
         5> else:
         6> start the HARQ-RTT-TimerUL-NTN for the corresponding HARQ process in the first symbol after the end of the first transmission (within a bundle) of the corresponding PUSCH transmission.
      3> else:
         4> if drx-LastTransmissionUL is configured:
         5> start the drx-HARQ-RTT-TimerUL for the corresponding HARQ process in the first symbol after the end of the last transmission (within a bundle) of the corresponding PUSCH transmission.
      4> else:
         5> start the drx-HARQ-RTT-TimerUL for the corresponding HARQ process in the first symbol after the end of the first transmission (within a bundle) of the corresponding PUSCH transmission.
      3> stop the drx-RetransmissionTimerUL for the corresponding HARQ process.
   2> if the PDCCH indicates an SL transmission:
      3> if the PUCCH resource is configured:
         4> start the drx-HARQ-RTT-TimerSL for the corresponding HARQ process in the first symbol after the end of the corresponding PUCCH transmission carrying the SL HARQ feedback; or
         4> start the drx-HARQ-RTT-TimerSL for the corresponding HARQ process in the first symbol after the end of the corresponding PUCCH resource for the SL HARQ feedback when the PUCCH is not transmitted;
         4> stop the drx-RetransmissionTimerSL for the corresponding HARQ process.
      3> else:
         4> start the drx-HARQ-RTT-TimerSL for the corresponding HARQ process at the first symbol after end of PDCCH occasion;
         4> stop the drx-RetransmissionTimerSL for the corresponding HARQ process.
   2> if the PDCCH indicates a to skip a measurement gap on a Serving Cell in this DRX group:
      3> start drx-MgTimer for this DRX group in the first symbol after the end of the PDCCH reception plus MG-offset, if configured.

In implementations, the drx-InactivityTimer can be started in response to the indication to skip a measurement gap, e.g., if the time offset between the indication and the measurement gap is larger than a threshold. In an example, a new value for the drx-InactivityTimer is applied in case a PDCCH/DCI which starts the drx-InactivityTimer indicates to skip a measurement gap. In one example, a UE is configured with two drx-InactivityTimer configurations, e.g. two values for the drx-InactivityTimer respectively two instances of drx-InactivityTimer. The first drx-InactivityTimer can be applied for the legacy DRX operation (e.g., when PDCCH indicates a new transmission (DL, UL or SL) on a serving cell for a DRX group), whereas the second the drx-Inactivity Timer can be applied for cases where the DCI/PDCCH indicates to skip a measurement gap. The drx-Inactivity Timer can also be started for cases where the DCI indicating to skip a measurement gap is not allocating resources for a PDSCH, e.g., DCI only. In one example the drx-Inactivity Timer can be started at an offset after receiving the DCI indicating to skip a measurement gap. In cases of cross carrier scheduling, the DCI which indicates skipping of a measurement gap on a scheduled cell, if the scheduled cell belongs to a different DRX group than that of the scheduling DCI, one of the following can apply: The UE does not consider the skipped measurement gap as DRX ActiveTime; The UE does not start the drx-InactivityTimer; The UE starts the drx-InactivityTimer with a different configuration or different starting point/offset.

FIG. 3 illustrates an example timing diagram 300 in accordance with aspects of the present disclosure. The timing diagram 300 may implement various aspects of the present disclosure described herein. For example, the timing diagram 300 may include one or more operations and/or signaling performed by one or more of a NE or a UE as described herein. In the following description of the timing diagram 300, one or more operations and/or signaling may be performed in different orders or at different times than the example order or times shown. Some operations and/or signaling may also be omitted, or other operations and/or signaling may be added.

By way of example, a NE 102 (e.g., a base station) may transmit, and a UE 104 may receive, a DCI 302 with a configuration indicating PDCCH monitoring occasions for the reception of a PDCCH indicating to skip a measurement gap. In an example, the PDCCH monitoring occasion(s) 304 for the reception of an DCI/PDCCH (e.g., DCI 302) indicating to skip a measurement gap is configured to be an offset 306 (e.g., a minimum gap in time, symbols, slots) before a measurement gap. In one example a skip window 308 (e.g., a time window) starting an offset 310 before a measurement gap is configured during which a PDCCH/DCI indicating to skip to measurement gap may be received. A UE may monitor PDCCH/DCI during the skip window 308, e.g., the UE is in DRX ActiveTime during the skip window 308. In one example the skip window 308 is of length 1, e.g., the length is one symbol, one slot, or one ms. In one example the offset 310 (e.g. MG-offset) is configured which indicates the start of the search-time of the DCI format used to indicate to skip a measurement gap 312 (also referred to as a skipped measurement gap) relative to the start of a measurement gap. In an example, the UE may be in DRX ActiveTime and monitor PDCCH/DCI at the configured occasions where a DCI indicating to skip a measurement gap can be received, e.g. the offset 310 before a measurement gap. The timing diagram 300 also includes a measurement gap 314 that is not skipped. For instance, DCI/PDCCH indicating to skip the measurement gap 314 is not received within the skip window 308.

In implementations, a UE can report CSI/SRS during a skipped measurement gap. For instance, a UE can report one of the following UCI during a skipped measurement gap or a combination thereof: Periodic SRS; Semi-persistent SRS; Periodic CSI; Semi-persistent CSI; periodic CSI that is L1-RSRP; periodic CSI that is not L1-RSRP. In an example a UE is configured by NE whether or not to report one or more UCI (e.g., as described above) during a skipped measurement gap.

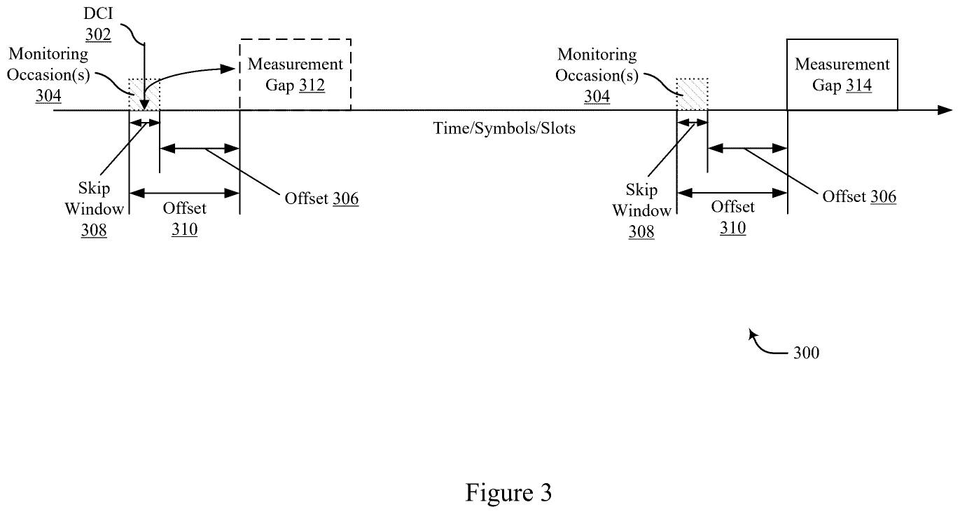

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving an indication to skip measurement for radio resource management, where the measurement is associated with a duration; and monitoring PDCCH during the duration based at least in part on the received indication to skip the measurement.

Additionally, the UE 400 may be configured to support any one or combination of where the indication to skip the measurement includes an indication to skip a measurement gap, and indicates that the UE is to enable wireless communication during the duration; further including: receiving a timer configuration; and starting a timer in accordance with the received timer configuration and based at least in part on the indication to skip the measurement, where the PDCCH is monitored further based at least in part on the timer; the timer is started at a first offset after the indication to skip the measurement; the timer configuration indicates the first offset; the timer includes a DRX inactivity timer; the indication to skip the measurement includes one or more of PDCCH or DCI; the indication to skip the measurement is received during a PDCCH monitoring occasion; further including: receiving configuration information that indicates the PDCCH monitoring occasion; the configuration information indicates a second offset before a measurement gap for the PDCCH monitoring occasion; further including: transmitting UCI during the duration; the UCI includes one or more of CSI or SRS.

Additionally, or alternatively, the UE 400 may support at least one memory (e.g., the memory 404) and at least one processor (e.g., the processor 402) coupled with the at least one memory and configured to cause the UE to receive an indication to skip measurement for radio resource management, where the measurement is associated with a duration; and monitor PDCCH during the duration based at least in part on the received indication to skip the measurement.

Additionally, the UE 400 may be configured to support any one or combination of where the indication to skip the measurement includes an indication to skip a measurement gap, and indicates that the UE is to enable wireless communication during the duration; the at least one processor is configured to cause the UE to: receive a timer configuration; and start a timer in accordance with the received timer configuration and based at least in part on the indication to skip the measurement, where the PDCCH is monitored further based at least in part on the timer; the timer is started at a first offset after the indication to skip the measurement; the timer configuration indicates the first offset; the timer includes a DRX inactivity timer; the indication to skip the measurement includes one or more of PDCCH or DCI; the indication to skip the measurement is received during a PDCCH monitoring occasion; the at least one processor is configured to cause the UE to: receive configuration information that indicates the PDCCH monitoring occasion; the configuration information indicates a second offset before a measurement gap for the PDCCH monitoring occasion; the at least one processor is configured to cause the UE to: transmit UCI during the duration; the UCI includes one or more of CSI or SRS.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

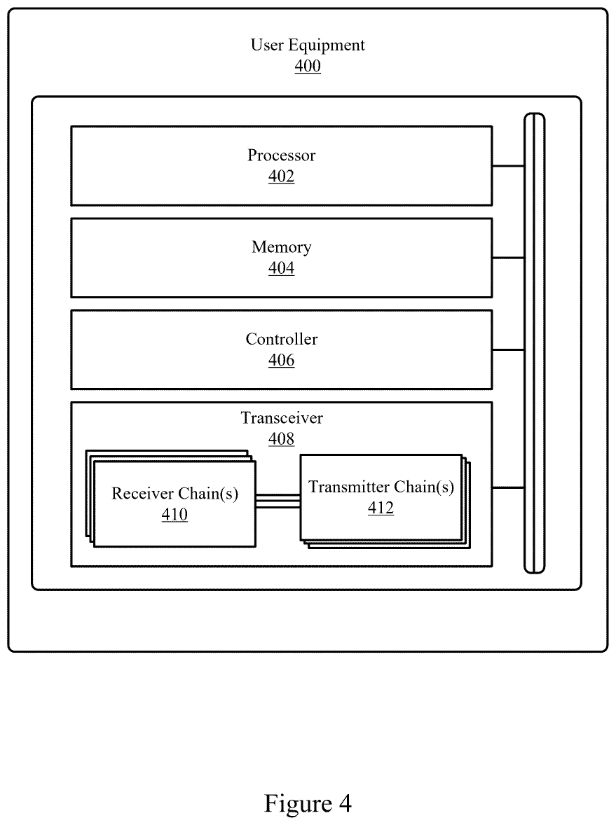

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to receive an indication to skip measurement for radio resource management, where the measurement is associated with a duration; and monitor PDCCH during the duration based at least in part on the received indication to skip the measurement.

Additionally, the processor 500 may be configured to or operable to support any one or combination of where the indication to skip the measurement includes an indication to skip a measurement gap, and indicates that the processor is to enable wireless communication during the duration; the at least one controller is configured to cause the processor to: receive a timer configuration; and start a timer in accordance with the received timer configuration and based at least in part on the indication to skip the measurement, where the PDCCH is monitored further based at least in part on the timer; the timer is started at a first offset after the indication to skip the measurement; the timer configuration indicates the first offset; the timer includes a DRX inactivity timer; the indication to skip the measurement includes one or more of PDCCH or DCI; the indication to skip the measurement is received during a PDCCH monitoring occasion; the at least one controller is configured to cause the processor to: receive configuration information that indicates the PDCCH monitoring occasion; the configuration information indicates a second offset before a measurement gap for the PDCCH monitoring occasion; the at least one controller is configured to cause the processor to: transmit UCI during the duration; the UCI includes one or more of CSI or SRS.

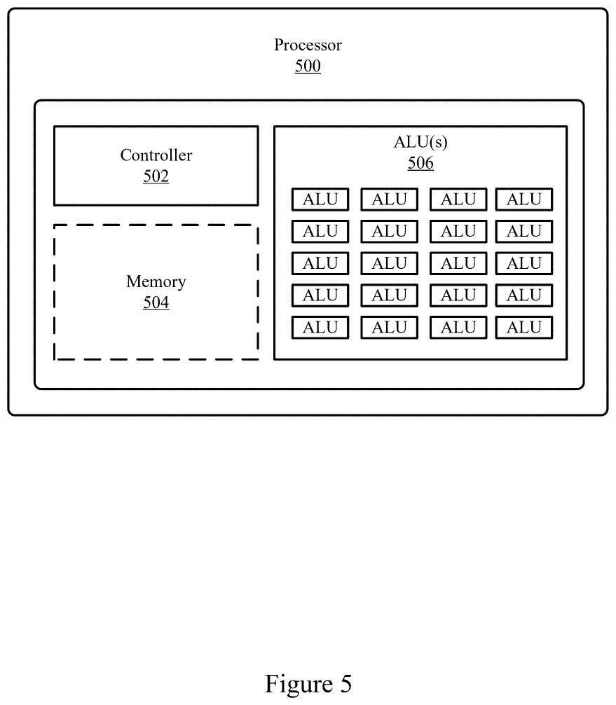

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting an indication to skip measurement for radio resource management, where the measurement is associated with a duration; and transmitting PDCCH during the duration.

Additionally, the NE 600 may be configured to or operable to support any one or combination of where the indication to skip the measurement includes an indication to skip a measurement gap, and an indication for a UE to enable wireless communication during the duration; further including: transmitting a timer configuration for a timer to be started in response to the indication to skip the measurement; the timer configuration includes a first offset to be applied to starting the timer in response to the indication to skip the measurement; further including transmitting configuration information including an indication of a PDCCH monitoring occasion for receiving the indication to skip the measurement; the indication to skip the measurement includes one or more of PDCCH or DCI.

Additionally, or alternatively, the NE 600 may support at least one memory (e.g., the memory 604) and at least one processor (e.g., the processor 602) coupled with the at least one memory and configured to cause the NE to transmit an indication to skip measurement for radio resource management, where the measurement is associated with a duration; and transmit PDCCH during the duration.

Additionally, the NE 600 may be configured to support any one or combination of where the indication to skip the measurement includes an indication to skip a measurement gap, and an indication for a UE to enable wireless communication during the duration; the at least one processor is configured to cause the NE to: transmit a timer configuration for a timer to be started in response to the indication to skip the measurement; the timer configuration includes a first offset to be applied to starting the timer in response to the indication to skip the measurement; the at least one processor is configured to cause the NE to transmit configuration information including an indication of a PDCCH monitoring occasion for receiving the indication to skip the measurement; the indication to skip the measurement includes one or more of PDCCH or DCI.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

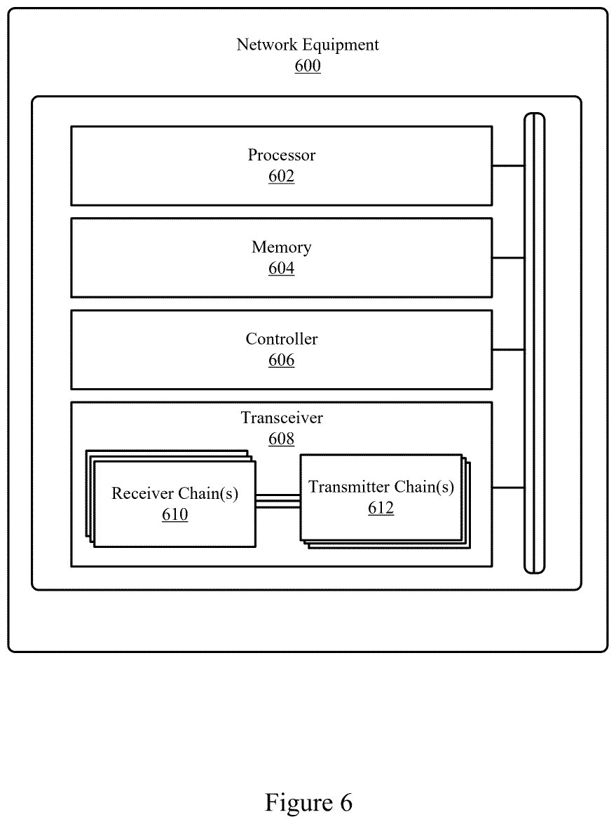

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving an indication to skip measurement for radio resource management, where the measurement is associated with a duration. The operations of 702 may be performed in accordance with examples as described herein. In some implementations, aspects of the operations of 702 may be performed by a UE as described with reference to FIG. 4.

At 704, the method may include monitoring PDCCH during the duration based at least in part on the received indication to skip the measurement. The operations of 704 may be performed in accordance with examples as described herein. In some implementations, aspects of the operations of 704 may be performed by a UE as described with reference to FIG. 4.

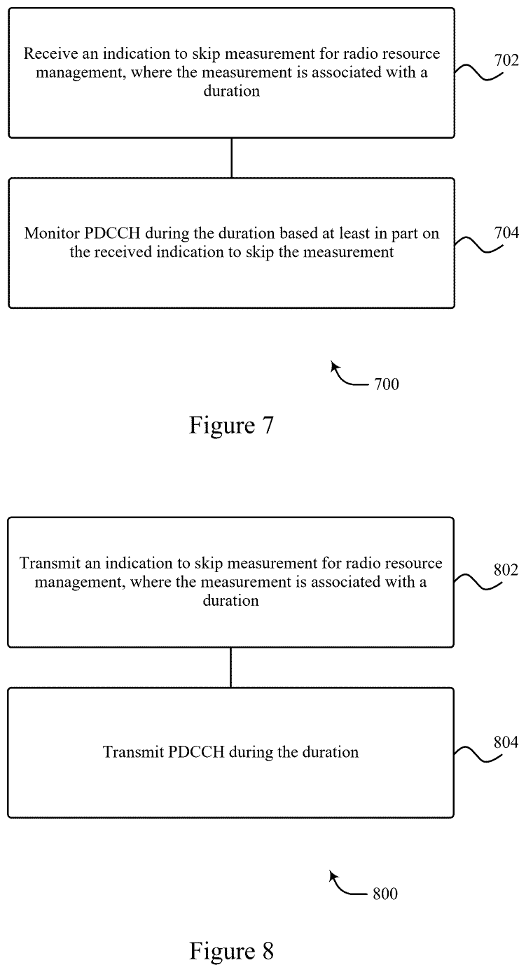

FIG. 8 illustrates a flowchart of a method 800 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include transmitting an indication to skip measurement for radio resource management, where the measurement is associated with a duration. The operations of 802 may be performed in accordance with examples as described herein. In some implementations, aspects of the operations of 802 may be performed by a NE as described with reference to FIG. 6.

At 804, the method may include transmitting PDCCH during the duration. The operations of 804 may be performed in accordance with examples as described herein. In some implementations, aspects of the operations of 804 may be performed by a NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive an indication to skip measurement for radio resource management, wherein the measurement is associated with a duration; and
monitor physical downlink control channel (PDCCH) during the duration based at least in part on the received indication to skip the measurement.

2. The UE of claim 1, wherein the indication to skip the measurement includes an indication to skip a measurement gap, and indicates that the UE is to enable wireless communication during the duration.

3. The UE of claim 1, wherein the at least one processor is configured to cause the UE to:
receive a timer configuration; and
start a timer in accordance with the received timer configuration and based at least in part on the indication to skip the measurement,
wherein the PDCCH is monitored further based at least in part on the timer.

4. The UE of claim 3, wherein the timer is started at a first offset after the indication to skip the measurement.

5. The UE of claim 4, wherein the timer configuration indicates the first offset.

6. The UE of claim 3, wherein the timer includes a discontinuous reception (DRX) inactivity timer.

7. The UE of claim 1, wherein the indication to skip the measurement comprises one or more of PDCCH or downlink control information (DCI).

8. The UE of claim 1, wherein the indication to skip the measurement is received during a PDCCH monitoring occasion.

9. The UE of claim 8, wherein the at least one processor is configured to cause the UE to:
receive configuration information that indicates the PDCCH monitoring occasion.

10. The UE of claim 9, wherein the configuration information indicates a second offset before a measurement gap for the PDCCH monitoring occasion.

11. The UE of claim 1, wherein the at least one processor is configured to cause the UE to:
transmit uplink control information (UCI) during the duration.

12. The UE of claim 11, wherein the UCI comprises one or more of channel state information (CSI) or sounding reference signal (SRS).

13. A processor for wireless communication, comprising:
at least one controller coupled with at least one memory and configured to cause the processor to:
receive an indication to skip measurement for radio resource management, wherein the measurement is associated with a duration; and
monitor physical downlink control channel (PDCCH) during the duration based at least in part on the received indication to skip the measurement.

14. A method performed by a user equipment (UE), the method comprising:
receiving an indication to skip measurement for radio resource management, wherein the measurement is associated with a duration; and
monitoring physical downlink control channel (PDCCH) during the duration based at least in part on the received indication to skip the measurement.

15. A network equipment (NE) for wireless communication, comprising:
at least one memory; and
at least one processor coupled with the at least one memory and configured to cause the NE to:
transmit an indication to skip measurement for radio resource management, wherein the measurement is associated with a duration; and
transmit physical downlink control channel (PDCCH) during the duration.

16. The NE of claim 15, wherein the indication to skip the measurement comprises an indication to skip a measurement gap, and an indication for a user equipment (UE) to enable wireless communication during the duration.

17. The NE of claim 15, wherein the at least one processor is configured to cause the NE to:
transmit a timer configuration for a timer to be started in response to the indication to skip the measurement.

18. The NE of claim 17, wherein the timer configuration comprises a first offset for starting the timer in response to the indication to skip the measurement.

19. The NE of claim 15, wherein the at least one processor is configured to cause the NE to transmit configuration information including an indication of a PDCCH monitoring occasion for receiving the indication to skip the measurement.

20. The NE of claim 15, wherein the indication to skip the measurement comprises one or more of PDCCH or downlink control information (DCI).
